(19) United States
(12) Patent Application Publication
(10) Pub. No.: US 2008/0265735 A1
(43) Pub. Date: Oct. 30, 2008

(54) Mounting Assembly for Metal Halide Lamp and Its Shroud

(75) Inventor: Joseph Carbone, Hornell, NY (US)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 12/090,511

(22) PCT Filed: Oct. 31, 2006
(86) PCT No.: PCT/IB06/54030

§ 371 Date: Apr. 17, 2008

Related U.S. Application Data
(60) Provisional application No. 60/731,819, filed on Oct. 31, 2005.

(51) Int. Cl. H01J 1/02; H01J 61/04

(52) U.S. Cl. 313/25; 313/634

(57) ABSTRACT

A protected arc tube mounting assembly for a metal halide arc lamp includes: a fused quartz arc tube (41) having a discharge space (42) with a discharge-sustaining fill and discharge electrodes (43, 44) at opposite ends of the discharge space (42); a fused quartz protective shroud (49); and a starter electrode (61) adjacent to one of the discharge electrodes (44) connected to a starter circuit (63). The arc tube (41) is suspended from above by a lead-through (47) connected to a first support member (56), and is supported from below by another lead-through (48) connected to a second support member (57). Further support is provided to the arc tube (41) by the first support member (56) via the starter circuit (63). The shroud (49) is supported by a pair of mounting clips (67, 68) attached to the first support member (56).

This invention relates to metal halide arc lamps, and more particularly relates to an improved protected arc tube mounting assembly for a metal halide arc lamp, and also relates to a metal halide lamp incorporating such an improved assembly.

Metal halide arc lamps of medium wattage (>175 W to 400 W) have an arc tube of quartz glass (fused silica) which typically is sealed at both ends by a press seal. Conductive lead-throughs extend through the press seal in a gas-tight manner to a pair of discharge electrodes arranged within the discharge vessel. The arc tube is typically surrounded by a protective quartz glass shroud. The arc tube and the shroud are enclosed within an outer glass envelope having a dome end and a base end. The envelope is sealed at the base end by an inwardly projecting lamp stem.

The arc tube is supported within the shroud by a metallic support structure, and the shroud is in turn supported within the glass envelope by a frame of metallic support rods which extend from the lamp stem at the base end to an inwardly projecting dimple at the dome end of the envelope.

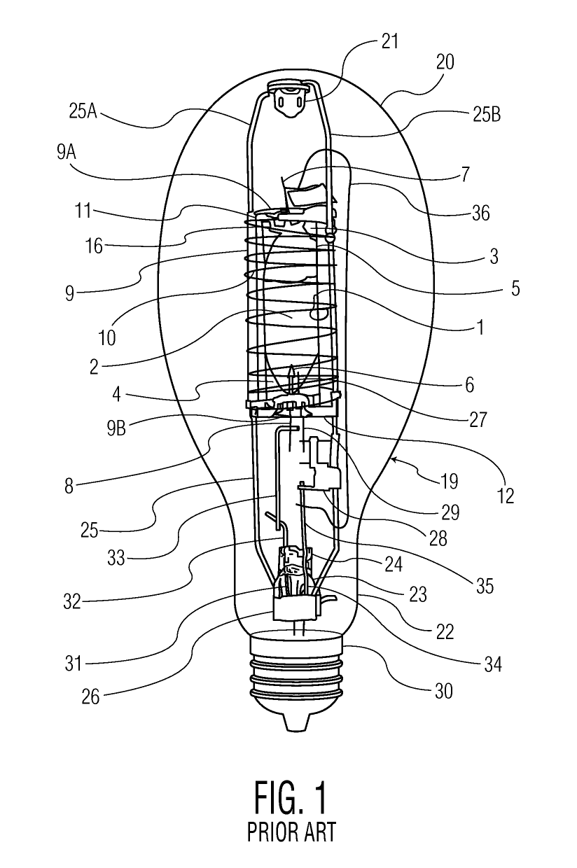

One example of such a metal halide arc lamp is shown in FIG. 1, in which arc tube 1, typically of fused quartz, encloses a discharge space 2 containing a fill capable of sustaining an arc discharge. The discharge space 2 is sealed by means of press seals 3 and 4. A pair of discharge electrodes 5 and 6 are arranged at opposite ends of the discharge space 2, and extend partially into press seals 43 and 44, where they are electrically connected to conductive lead-throughs 47 and 48, which extend out of the press seals in a gas-tight manner.

Surrounding arc tube 1 is a cylindrically-shaped protective shroud 9, also of fused quartz. Surrounding shroud 9 is a helically-wrapped wire 10, which provides additional protection in the event of lamp failure, as well as serving as a field wire.

The arc tube 1 is supported within the shroud 9 by metallic support clips 11 and 12, one of which is shown in perspective view in FIG. 4. Clip 12 has a saddle-shaped portion 13, which fits over the end of the press seal 4, and terminal portions 15 and 16, which fit over opposite sides of the end wall of the shroud 9. Terminal portions 15 and 16 have beds 15A and 16A, which contact the bottom edge of the press seal 4, as well as the end wall of the shroud 9. Clips 15 and 16 have upstanding posts 15B and 16A, which contact the outer surface of shroud 9. Post 16B supports laterally extending arms 17A and 17B, which wrap around the outside surface of shroud 9.

Outer glass envelope 19, encloses the arc tube 1 and protective shroud 9, and has a dome end 20 with an inwardly projecting dimple 21, and a base end 22 with an inwardly projecting lamp stem 23, sealed by press seal 24. Metal frame 25 wraps around dimple 21 and has two arms 25a and 25b which each extend downward along opposite sides of shroud 9, and then to base 22, where they are secured to lamp stem 23 by strap 26. Shroud 9 is supported by frame 25 via metallic supports 11 and 12, which are attached both to the frame 25 and to the helical support wire 10.

A starting electrode 27 extends into discharge space 2 adjacent to discharge electrode 6, and is connected to starting circuit 28 via lead-through 29. Power to discharge electrode 6 is provided by screw base 30, via lead-through 31 and support rods 32 and 33. Power to discharge electrode 5 and starting electrode 27 is also provided by screw base 30, via lead-through 34, support rod 35 and field wire 36.

This lamp has a significant amount of metal parts. These parts are thought necessary to provide a support structure which is sufficiently rigid to pass the pre-shipment 30″ drop test criteria which is common in the industry. However, these metal parts increase the complexity of the manufacturing process, leading to increased costs.

Moreover, metal parts in the vicinity of the arc tube 1, such as helical support wire 20, and the two axially extending support rods of frame 25, can affect lamp performance by emitting photoelectrons upon excitation by direct UV radiation from the arc tube. Such photoelectrons create a negative space discharge which leads to sodium loss by diffusion through the arc tube wall. Such sodium loss alters the chemical composition of the fill, leading to undesirable changes in the spectral output of the lamp. Moreover, other metal parts not in the vicinity of the arc tube can also be a significant source of photoelectrons, when excited by UV radiation reflected off the inner surface of the outer envelope. See in this regard published international patent application WO2005/001886, published Jun. 26, 2004.

It is an object of the invention to provide a medium wattage metal halide lamp that reduces metal parts, which metal parts not only increase costs but also negatively impact the photoelectric properties of the lamp by contributing to sodium diffusion.

It is another object of the invention to provide such a lamp which can survive handling and processing and reliably pass a standard drop test that is customary in lamp manufacturing.

According to one aspect of the invention, there is provided a protected arc tube mounting assembly for a metal halide arc lamp, which includes an arc tube having a discharge space with a discharge-sustaining fill and discharge electrodes at opposite ends of the discharge space, a protective shroud. The arc tube is suspended from above by a lead-through connected to a first support member, and is supported from below by another lead-through connected to a second support member. Preferably, further support is provided to the arc tube from below by the first support member via a starter circuit and lead-through connected to a starter electrode positioned in the discharge space adjacent to one of the discharge electrodes. The shroud is supported by a pair of mounting clips attached to upper and lower ends of the shroud and to the first support member.

According to one embodiment of the invention, there is provided a protected arc tube mounting assembly for a metal halide arc lamp, the assembly comprising:

an arc tube enclosing a discharge space containing a fill capable of sustaining an arc discharge;

first and second discharge electrodes arranged at opposite ends of the discharge space;

a first lead-through electrically connected to the first discharge electrode, and a second lead-through electrically connected to the second discharge electrode, the first and second lead-throughs passing out of opposite ends of the arc tube in a gas-tight manner;

a protective shroud surrounding the arc tube;

a first electrically conducting support member positioned adjacent to one side of shroud and extending above and below shroud, the first support member electrically connected to the first lead-through;

a second, smaller electrically conducting support member extending below shroud and spaced apart from the first support member, the second support member electrically connected to the second lead-through; and

at least first and second mounting clips, mounted on opposite ends of the shroud, and attached to the first support member.

According to a preferred embodiment of the invention, the protected arc tube mounting assembly additionally comprises:

a starting electrode positioned adjacent to the second discharge electrode in discharge space;

a lead-through electrically connected to the starting electrode and passing out of the arc tube in a gas-tight manner; and

a starting circuit electrically connected to the lead-through and to the first support member.

According to another preferred embodiment, the first support member comprises an upper support rod, a main support rod electrically connected to the upper support rod, and a lower support rod electrically connected to the main support rod. The upper support rod has an upper end adapted for attachment to a lamp envelope. The second support member comprises an upper support rod and a lower support rod electrically connected to each other.

According to another preferred embodiment, at least one of the mounting clips comprises:

a bed for making contact with the end wall of the shroud;

at least one outer clip, upstanding from an outer edge of the bed for making contact with the outer surface of the shroud;

an inner clip, upstanding from an inner edge of bed the for making contact with the inner surface of the shroud, the inner clip having a center upstanding post, at least one laterally extending arm, and at least one terminal spherical contact member for making contact with the inner surface of the shroud; and

a bracket extending downwardly from the outer edge of the bed for attachment to the first support member, the bracket having a downwardly extending tab and a wing extending at a right angle to the tab. The bed preferably has a curvature along its length and a width which match the curvature and width, respectively, of the end wall of the shroud. Preferably, the surface of the contact member facing the outer edge of the bed is convex, so as to provide minimal contact with the inner surface of the shroud.

Preferably, the arc tube is mounted so that the edges of the press seals of the arc tube are adjacent to the first support member, and at least one of the mounting clips is mounted on the shroud so that at least one of the laterally extending arms prevents contact between the shroud and the adjacent edge of the press seal.

Preferably, the mounting clips have the same construction, and are each fabricated from a single sheet of spring material.

According to another aspect of the invention, the protected arc tube mounting assembly of the invention is provided a metal halide arc lamp comprising:

an outer envelope having a dome end with an inwardly projecting dimple and a base end with an inwardly projecting lamp stem terminating in a press seal;

a screw base attached to the base end of the outer envelope;

a pair of lead-throughs electrically connected to the screw base and passing through the press seal of the lamp stem. The first support member of the mounting assembly is attached at one end of the lamp envelope to the dimple and at the other end to one of the lamp lead-throughs, and the smaller support member is connected at one end to the second arc tube lead-through and at the other end to the other lamp lead-through.

These and other aspects of the invention will be further elucidated with reference to the Figures, in which:

FIG. 1 shows a prior art metal halide arc lamp having a protected arc tube;

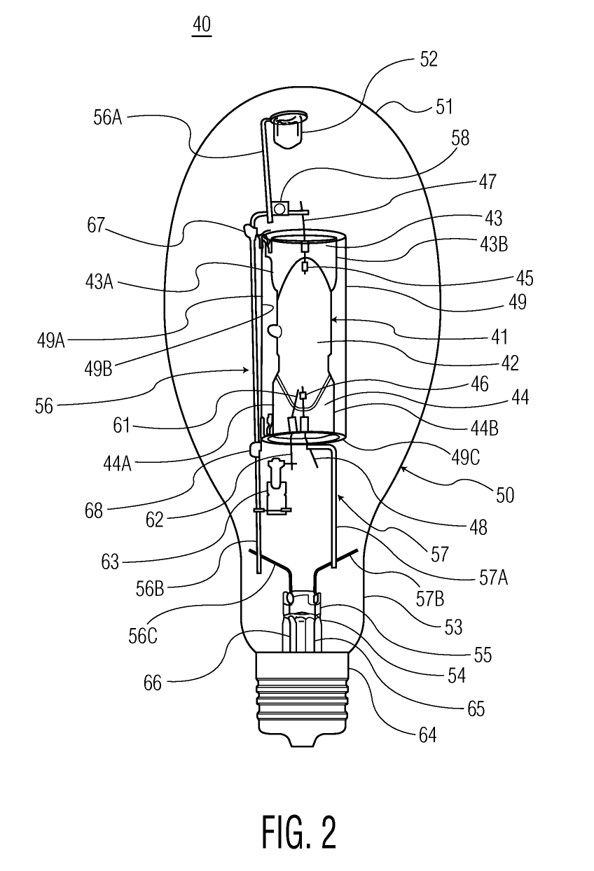

FIG. 2 shows one embodiment of a metal halide arc lamp having a protected arc tube of the invention;

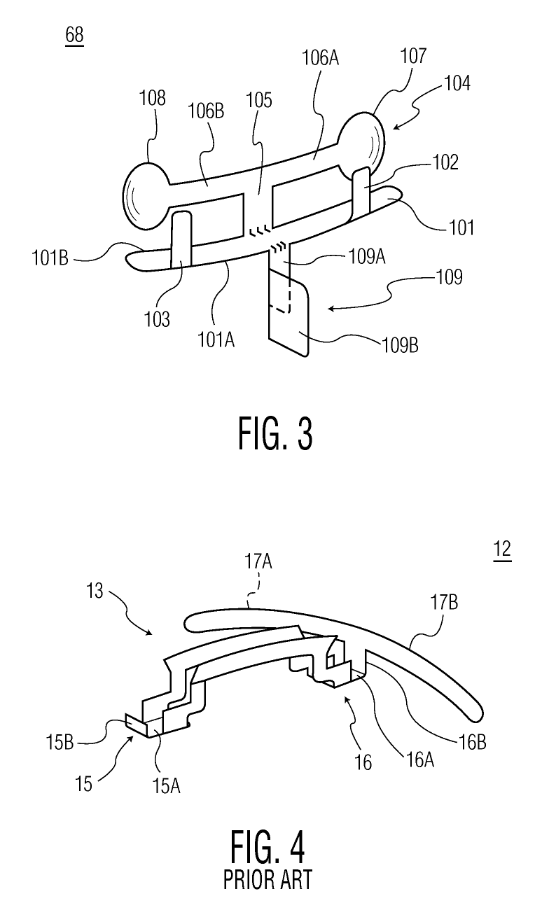

FIG. 3 is a perspective view of one embodiment of a mounting clip suitable for use in the arc tube mounting assembly of invention;

FIG. 4 shows another embodiment of an arc tube mounting assembly for a metal halide arc lamp of the invention.

The Figures are diagrammatic and not drawn to scale. The same reference numbers in different Figures refer to like parts.

Referring now to FIG. 2, there is shown one embodiment of a metal halide lamp 40 of the invention, having an improved protected arc tube assembly. Arc tube 41, typically of fused quartz, encloses a discharge space 42 containing a fill capable of sustaining an arc discharge. The discharge space 42 is sealed by means of press seals 43 and 44, having edges 43A and 43B, and 44A and 44B, respectively. A pair of discharge electrodes 45 and 46 are arranged at opposite ends of the discharge space 42, and extend partially into press seals 43 and 44, where they are electrically connected to conductive lead-throughs 47 and 48, which extend out of the press seals in a gas-tight manner.

Surrounding arc tube 41 is a cylindrically-shaped protective shroud 49, also of fused quartz, having an outer surface 49A, an inner surface 49B and end surfaces 49C. Enclosing arc tube 41 and protective shroud 49 is outer glass envelope 50, which has a dome end 51 with an inwardly projecting dimple 52, and a base end 53 with an inwardly projecting lamp stem 54, sealed by press seal 55.

An electrically conducting support structure for the protected arc tube consists of a first metal support member 56 and a second smaller metal support member 57. First support member 56 is made up of an upper support rod 56A, which is attached to the lamp envelope 50 by wrapping one end around dimple 52. The other end extends downward to a position above the top of shroud 49, where it is electrically connected to a main support rod 56B, which is electrically connected at one end to lead-through 47, and extends downward along the side of shroud 49 to above the top of press seal 55, where the other end is connected to a lower support rod 56C, which extends into and is secured by press seal 55. The smaller support member 57 consists of a lower support rod 57B, the lower end of which is also secured by press seal 55, and the upper end of which is electrically connected to upper support rod 57A, which extends upward to a position below the bottom of shroud 49, where it is electrically connected to lead-through 48.

A starting electrode 61 extends into discharge space 42 adjacent to discharge electrode 46, and is connected to starting circuit 63 via lead-through 62. Power to discharge electrode 46 is provided by screw base 64, via lead-through 65, support rod 59 and frame member 60, and lead-through 48. Power to discharge electrode 45 and starting electrode 61 (via lead-through 62 and starting circuit 63) is also provided by screw base 64, via lead-through 66, support rod 58 and frame member 57.

Shroud 49 is secured in position by upper and lower mounting clips 67 and 68 (more clearly shown in FIG. 3), which clip onto the upper and lower edges of shroud 49 and are attached to main frame member 57. Inner portions of mounting clips 67 and 68 extend a short distance into shroud 49 to prevent contact between shroud 49 and press seals 43 and 44 of arc tube 41.

Arc tube 41 is not supported by shroud 49, but merely suspended therein by lead-through 47, which is attached to the upper end of main frame member 57, and supported from below by lead-throughs 48 and 62, which are attached to frame member 60 and frame member 57 via starting circuit 63, respectively.

Elements of the prior art lamp which have been eliminated include the helically-wrapped wire 10; metallic supports 11 and 12, including saddle-shaped portions 13 and 14 and terminal clips 15, 16, 17 and 18; frame 25; strap 26;

FIG. 3 is a perspective view of the lower mounting clip 68, which includes a bed 101, outer clips 102 and 103 upstanding from an outer edge 101A of bed 101, and inner clip 104, upstanding from an inner edge 101B of bed 101. Inner clip 104 includes a center upstanding post 105, laterally extending arms 106A and 106B, and terminal spherical contact members 107 and 108. Extending downwardly from outer edge 101A of bed 101 is bracket 109 having a tab 109A and a wing 109B extending at right angles to tab 109A.

The bed 101 has a curvature along its length and a width which match the curvature and width, respectively, of the wall of shroud 49, so that clip 68 can be slid onto an edge of the wall opposite main frame member 57, and secured in place by attaching tab 109A and wing 109B of bracket 109 to main frame member 57, e.g., by spot welding. The surfaces of contact members 107 and 108 facing outer edge 101A of bed 101 are convex, so as to provide minimal contact with the inner surface of shroud 49. Arc tube 41 is mounted so that main frame member 57 runs along shroud 49 adjacent to the edges of press seals 43 and 44. In this position, the arms 106A and 106B prevent contact between the inner wall of shroud 49 and press seals 43 and 44.

It will be appreciated that the upper mounting clip 67 may be of identical construction to lower mounting clip 68, and that the clips may be readily fabricated such as by stamping, bending and forming a single piece of a suitable sheet material, such as spring steel.

The invention has necessarily been described in terms of a limited number of embodiments. From this description, other embodiments and variations of embodiments will become apparent to those skilled in the art, and are intended to be fully encompassed within the scope of the invention and the appended claims.

1. A protected arc tube mounting assembly for a metal halide arc lamp, the assembly comprising:
an arc tube (41) enclosing a discharge space (42) containing a fill capable of sustaining an arc discharge;
first (45) and second (46) discharge electrodes arranged at opposite ends of the discharge space (42);
a first lead-through (47) electrically connected to the first discharge electrode (46), and a second lead-through (48) electrically connected to the second discharge electrode (46), the first and second lead-throughs (47, 48) passing out of opposite ends of the arc tube (41) in a gas-tight manner;
a protective shroud (49) surrounding the arc tube (41);
a first electrically conducting support member (56) positioned adjacent to one side of shroud (49) and extending above and below shroud (49), the first support member (56) electrically connected to the first lead-through (47);
a second electrically conducting support member (57) extending below shroud (49) and spaced apart from the first support member (56), the second support member (57) electrically connected to the second lead-through (48); and
at least first (67) and second (68) mounting clips, mounted on opposite ends of shroud (49), and attached to the first support member (56).

2. The protected arc tube mounting assembly as claimed in claim 1, the assembly additionally comprising:
a starting electrode (61) positioned adjacent to the second discharge electrode (46) in discharge space (42);
a third lead-through (62) electrically connected to the starting electrode (61) and passing out of the arc tube (41) in a gas-tight manner; and
a starting circuit (63) electrically connected to the third lead-through (62) and to the first support member (56).

3. The protected arc tube mounting assembly as claimed in claim 1, wherein the first support member (56) comprises an upper support rod (56A), a main support rod (56B), and a lower support rod (56C).

4. The protected arc tube mounting assembly as claimed in claim 3, wherein: the upper support rod (56A) of the first support member (56) has an upper end adapted for attachment to a lamp envelope, and a lower end; the main support rod (56B) has an upper end attached to the lower end of the upper support rod (56A) and a lower end; and the lower support rod (56C) has an upper end attached to the lower end of the main support rod (56B) and a lower end.

5. The protected arc tube mounting assembly as claimed in claim 1, wherein the second support member (57) comprises an upper support rod (57A) and a lower support rod (57B) attached to the upper support rod (57A).

6. The protected arc tube mounting assembly as claimed in claim 4, wherein the starting circuit (63) is electrically connected to the main support rod (56B).

7. The protected arc tube mounting assembly as claimed in claim 1, wherein the arc tube (41) comprises a fused quartz tube sealed at the ends by first and second press seals (43, 44) having first (43A, 44A) and second (43B, 44B) edges, respectively.

8. The protected arc tube mounting assembly as claimed in claim 7, wherein the protective shroud (49) comprises a fused quartz tube having an outer wall (49A), an inner wall (49B) and an end wall (49C).

9. The protected arc tube mounting assembly as claimed in claim 8, wherein at least the second mounting clip (68) comprises:
a bed (101) for making contact with the end wall (49C) of the shroud (49), the bed (101) having an outer edge (101A) and an inner edge (101B);
at least one outer clip (102, 103), upstanding from the outer edge (101A) of the bed (101) for making contact with the outer surface (49A) of the shroud (49);
an inner clip (104), upstanding from the inner edge (101B) of the bed (101) for making contact with the inner surface (49B) of the shroud (49), the inner clip (104) including a center upstanding post (105), at least one laterally extending arm (106A, 106B), and at least one terminal spherical contact member (107, 108); and
a bracket (109) extending downwardly from outer edge (101A) of the bed (101) for attachment to the first support member (56), the bracket (109) having a downwardly extending tab (109A) and a wing (109B) extending at a right angle to the tab (109B).

10. The protected arc tube mounting assembly as claimed in claim 9, wherein the bed (101) has a curvature along its length and a width which match the curvature and width, respectively, of the end wall (49C) of the shroud (49).

11. The protected arc tube mounting assembly as claimed in claim 9, wherein the surface of the spherical contact member (107) facing the outer edge (101A) of the bed (101) is convex, so as to provide minimal contact with the inner surface of the shroud (49).

12. The protected arc tube mounting assembly as claimed in claim 9, wherein the arc tube (41) is mounted so that the first edges (43A, 44A) of the press seals (43, 44) of the arc tube (41) are adjacent to the first support member (56), the mounting clip (68) is mounted on the shroud (49) adjacent to the edge (44A) of the press seal (44), so that the laterally extending arm (106A) prevents contact between the inner wall (49B) of the shroud (49) and the adjacent edge (44A) of the press seal (44).

13. The protected arc tube mounting assembly as claimed in claim 12, wherein the first mounting clip (67) has the same construction as the second mounting clip (68), and the first mounting clip (67) is mounted on the shroud (49) adjacent to the edge (43A) of the press seal (43), so that the mounting clip (67) prevents contact between the inner wall (49B) of the shroud (49) and the adjacent edge (43A) of press seal (43).

14. The protected arc tube mounting assembly as claimed in claim 13, wherein the first and second mounting clips (67, 68) each have first and second laterally extending arms (106A, 106B) terminating in spherical contact members (107, 108).

15. The protected arc tube mounting assembly as claimed in claim 14, wherein the first and second mounting clips (67, 68) are each fabricated from a single sheet of spring material.

16. A metal halide arc lamp comprising:
an outer envelope (50) having a dome end (51) with an inwardly projecting dimple (52) and a base end (53) with an inwardly projecting lamp stem (54) terminating in a third press seal (55);
a screw base (64) attached to the base end (53) of the outer envelope (50);
fourth and fifth lead-throughs (65, 66) electrically connected to the screw base (64) and passing through the third press seal (55); and
the protected arc tube mounting assembly as claimed in claim 1, wherein the support member (56) is attached at one end to the dimple (52) and at the other end to the fifth lead-through (66), and the support member (57) is electrically connected at one end to the second lead-through (48) and is electrically connected at the other end to the fourth lead-through (65).
